(19) United States
(12) Patent Application Publication
(10) Pub. No.: US 2012/0254890 A1
(43) Pub. Date: Oct. 4, 2012

(54) Small Data Transmission For Detached Mobile Devices

(75) Inventors: Zhenhong Li, Shanghai (CN); Matti Jokimies, Salo (FI); Wei Zou, Shanghai (CN)

(73) Assignee: Renesas Mobile Corporation

(21) Appl. No.: 13/078,074

(22) Filed: Apr. 1, 2011

(51) Int. Cl. G06F 9/46

(52) U.S. Cl. 719/313

(57) ABSTRACT

A M2M device sends on a random access channel an indication of a small data transmission, and thereafter sends the small data on an initial uplink resource allocated in response to the indication. The network sends a connection rejection message which the M2M device interprets as an acknowledgement of the small data it sent. In one embodiment the indication is explicit and also indicates priority, type and/or size of the small data. In another embodiment the indication is implicit such as a RACH preamble signature sequence reserved for this purpose, where different reserved sequences map to different sizes for the small data. If needed a second indication can be sent with the small data which indicates its type, size and/or priority. The connection rejection message may indicate the acknowledgement via a cause value, and in response the M2M device then automatically enters an idle or a detached mode.

### TECHNICAL FIELD

The exemplary and non-limiting embodiments of this invention relate generally to wireless communication systems, methods, devices and computer programs, and more specifically relate to small data transmissions such as might be sent by M2M devices which do not have a current connection with a host network.

### BACKGROUND

The following abbreviations that may be found in the specification and/or the drawing figures are defined as follows:

3GPP third generation partnership project

CCCH common control channel

C-RNTI cell RNTI

CS circuit switching

DL-SCH downlink shared channel

eNB evolved Node B

E-UTRAN evolved universal terrestrial radio access network (LTE)

LTE long term evolution

GGSN gateway GPRS support node

HARQ hybrid automatic repeat request

HLR home location register

HSS home subscriber server

IP Internet protocol

LTE long-term evolution

M2M machine-to-machine

MAC media access control

MME mobile management entity

MSC mobile switching center

MTC machine-type communication

NAS non-access stratum

PCO protocol configuration options

PDCCH physical downlink control channel

PDCP packet data convergence protocol

PGW packet data network gateway

PS packet switching

RACH random access channel

RA-RNTI random access RNTI

RNTI radio network temporary identifier

RRC radio resource control

SGSN serving GPRS support node

SIM subscriber identity module

TTI transmission time interval

UDP user datagram protocol

UE user equipment

UL uplink

UL-SCH uplink shared channel

M2M communications is the networking of intelligent, communications-enabled remote assets. It allows key information to be exchanged automatically without human intervention, and covers a broad range of technologies and applications which connect the physical world—whether machines or monitored physical conditions—to a back-end information technology IT infrastructure. M2M communications can be used for a variety of purposes such as immediate feedback on a remote asset, feature popularity, and specifics of errors and breakdowns to name a few.

M2M communications are made possible by the use of intelligent sensors or microprocessors that are embedded in the remote asset. These sensors are connected to a wireless modem, slightly different to the one in conventional mobile phones, which is able to receive and transmit data wirelessly to a central server where it can be analyzed and acted upon. Wireless communications technologies used to enable this connectivity include GSM, GPRS, CDMA, 3G, LTE, WiFi and WiMAX; and M2M communications can be over a relatively short range or a distance of many miles. Since there is a wide variety for M2M communications in both the types of data reported and the radio access technologies used, the traffic models are quite diverse and no single networking model is efficient for them all. For example, if M2M is applied to monitor and prevent natural disasters, a huge number of M2M devices may initiate services simultaneously, with each reporting a small amount of data to the application layer when triggered by an appropriate event. This is classified as an infrequent small data transmission. In conventional cellular systems a mobile terminal typically goes through a control signaling procedure to establish a data connection with the network before it can send user data. This is inefficient for infrequent small data transmissions since the conventional signaling overhead in setting up a data channel for the user terminal is high relative to the small volume of user data being reported by an M2M device.

Offline small data transmissions are detailed at 3GPP TR 23.888 v1.0.1 (2011-02), with an overview of the concept at section 5.5.1. The meaning/volume of ‘small’ is not defined and may differ from system to system and based on some subscription criteria, and the mobile device sending the small data transmissions is termed in general a MTC device which is assumed to be detached from and not context activated with the network when not transmitting data. The MTC application controlling transmission of any given small data may or may not know whether the host MTC device is available for wireless communication with the network and so may transfer data to a transmit buffer even if the host MTC device is not reachable by the network. “Offline” for the MTC device is also not yet fully defined but refers to the opposite of online; the MTC device is not attached to the network (e.g., for LTE the device is not in a connected state, and not in an ordinary idle state where the MTC device could be reached by a paging message).

There are a few other proposals for handling M2M offline small data transmissions. Specifically, document S2-102244 by ZTE entitled OFFLINE SMALL DATA TRANSMISSION (3GPP TSG SA WG2 Meeting #79, 10-15 May 2010; Koyto, Japan) proposes the MTC device encapsulate the small data in a Protocol Configuration Options (PCO) element during the PDP context activation or attach procedure, and then the GGSN/PGW unpacks the MTC data package and sends it to the MTC Server. At least one of these PCO suggestions is inside a NAS message, which contains several bytes of headers in the minimum. The inventors see this as problematic since the PCO element is not currently included in the initial NAS messages. Document S2-101453 by KPN entitled KEY ISSUE-OFFLINE SMALL DATA TRANSMISSION (3GPP TSG SA WG2 Meeting #78, 22-26 Feb. 2010; San Francisco, USA) proposes parameter extensions in the messages used in the CS, PS or combined CS/PS Attach procedures in which the small amount of user data is encapsulated in the Attach Request message sent from the MTC Device to the MSC/SGSN/MME in the network. The network then extracts the user data from the Attach Request message and normally proceeds with the Attach procedure to authenticate between the HLR/HSS, MSC/SGSN/MME and MTC Device. After authentication and sending the user data to the MTC Server there are different options to continue the Attach procedure.

These teachings are directed to a more efficient way to conduct infrequent small data transmissions.

### SUMMARY

The foregoing and other problems are overcome, and other advantages are realized, by the use of the exemplary embodiments of this invention.

In a first exemplary embodiment of the invention there is an apparatus comprising at least one processor and at least one memory storing a computer program. In this embodiment the at least one memory with the computer program is configured with the at least one processor to cause the apparatus to at least: send on a random access channel an indication of a small data transmission, and thereafter send the small data on an initial uplink resource allocated in response to the indication; and interpret a received connection rejection message as an acknowledgement of the small data which was sent.

In a second exemplary embodiment of the invention there is a method comprising: sending on a random access channel an indication of a small data transmission, and thereafter send the small data on an initial uplink resource allocated in response to the indication; and interpreting a received connection rejection message as an acknowledgement of the small data which was sent.

In a third exemplary embodiment of the invention there is a computer readable memory storing a set of instructions, which, when executed by an apparatus, causes the apparatus to: send on a random access channel an indication of a small data transmission, and thereafter send the small data on an initial uplink resource allocated in response to the indication; and interpret a received connection rejection message as an acknowledgement of the small data which was sent.

In a fourth exemplary embodiment of the invention there is an apparatus comprising at least one processor and at least one memory storing a computer program. In this embodiment the at least one memory with the computer program is configured with the at least one processor to cause the apparatus to at least: interpret a message received on a random access channel as an indication of a small data transmission, and thereafter receive the small data on an initial uplink resource allocated in response to the indication; and send a connection rejection message as an acknowledgement that the small data was received.

In a fifth exemplary embodiment of the invention there is a method comprising: interpreting a message received on a random access channel as an indication of a small data transmission, and thereafter receiving the small data on an initial uplink resource allocated in response to the indication; and sending a connection rejection message as an acknowledgement that the small data was received.

In a sixth exemplary embodiment of the invention there is a computer readable memory storing a set of instructions, which, when executed by an apparatus, causes the apparatus to interpret a message received on a random access channel as an indication of a small data transmission, and thereafter receive the small data on an initial uplink resource allocated in response to the indication; and send a connection rejection message as an acknowledgement that the small data was received.

These and other embodiments and aspects are detailed below with particularity.

### BRIEF DESCRIPTION OF THE DRAWINGS

FIG. 1 is a signaling diagram showing various messages and characteristics thereof in a RACH procedure adapted for small data transmissions according to an exemplary but non-limiting embodiment of the invention.

FIG. 2 is a logic flow diagram that illustrates the operation of a method, and a result of execution of a set of computer program instructions embodied on a computer readable memory, in accordance with exemplary embodiments of this invention.

FIG. 3 is a simplified block diagram of the MTC device in communication with a wireless network illustrated as an eNB and a serving gateway SGW, which are exemplary electronic devices suitable for use in practicing the exemplary embodiments of this invention.

### DETAILED DESCRIPTION

The inventors consider that the signaling overhead needed to setup a small data transmission from a MTC device to a network can be best limited by utilizing a modified RACH procedure. Conventionally, a mobile terminal not having a connection with a network will establish one by sending a randomly selected preamble on the RACH. The network's normal response to the preamble is to allocate some UL radio resource to the terminal, on which the terminal then sends a connection request. This connection request is then granted by establishing a connection with the network and only then does the terminal have an opportunity to send any UL user data.

Since other terminals in the conventional RACH procedure might be sending their own preambles at the same time, there are also procedures established to account for potential UL preamble message interferences. Namely, in case one terminal receives no response from the network to its UL preamble the terminal sends its next preamble with reference to a ‘backoff’ timing factor which randomizes the times different terminals might re-send their preambles after an interference, and there are also step-wise transmit power increases for each subsequent re-transmission which does not draw a response from the network. These procedures are sometimes necessary since each terminal sending its UL preamble on the RACH competes with other unknown terminals for the network's response. Such backoff timing factors and power incrementing may in an embodiment be continued in the modified RACH procedure detailed herein.

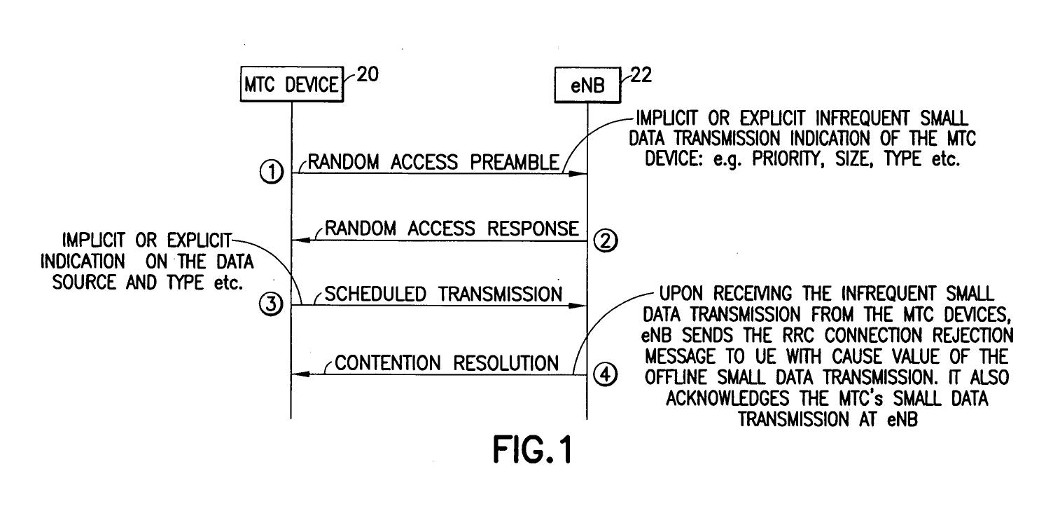

According to exemplary embodiments of these teachings, the above conventional RACH procedures are modified for infrequent small data transmissions by an MTC device in the LTE environment as is generally shown at the non-limiting signaling diagram of FIG. 1. There are in this modification several distinctions over the conventional RACH procedures.

First, there is an indication of a (yet to be sent) small data transmission which the MTC device includes in the RACH preamble it sends. From this indication the eNB learns about the coming infrequent offline small data transmission and can prepare the radio resources for it. In one embodiment this indication is explicit, for example the RACH preamble may explicitly indicate the priority and/or the type and/or the size of the infrequent offline small data transmission which is to follow. In another embodiment this indication is implicit, for example one or more signature sequences which the MTC device includes in its RACH preamble are reserved for indicating a pending small data transmission. The signature sequences for indicating the small data transmission may be pre-configured by the network. For the case in which a plurality of such signature sequences are reserved for this purpose, two or more of them may map to different sizes of the pending small data transmission so that the MTC device selects the one appropriate for the small data it seeks to send and thereby gives the network some knowledge in advance of how much UL user data will be arriving.

Second, the UL small data/user data is actually transmitted by the MTC device in the first or initial scheduled UL resource. In the conventional RACH procedure summarized above this first scheduled resource is used for the terminal's connection request message. In one embodiment this first/initial scheduled UL resource on which the MTC device sends the UL small data itself is an UL-SCH. In case the MTC device did not provide the priority and/or type and/or size of the infrequent offline small data transmission with the indication sent in the RACH preamble, that information may in an embodiment be included on the UL-SCH with the small data itself.

Third, after the eNB receives the infrequent small data transmission from the MTC device, it sends a RRC connection rejection message to the MTC device. In specific embodiments detailed below this specific connection rejection message serves as an acknowledgement to the MTC device that the eNB has properly received the small data which was sent in that first UL scheduled resource. Now with the small data being acknowledged, the MTC device can switch to the detached mode or some detached-like mode (e.g., offline mode) if by example the M2M specifications define some new name, other than detached, for the non RRC-connected mode after successful sending of infrequent small data. In an embodiment there is a cause value, specific for the purpose of offline small data transmission and known to the MTC devices such as via a published standard, which the network includes in this connection rejection message which serves to acknowledge the network's proper receipt of the MTC's small data transmission.

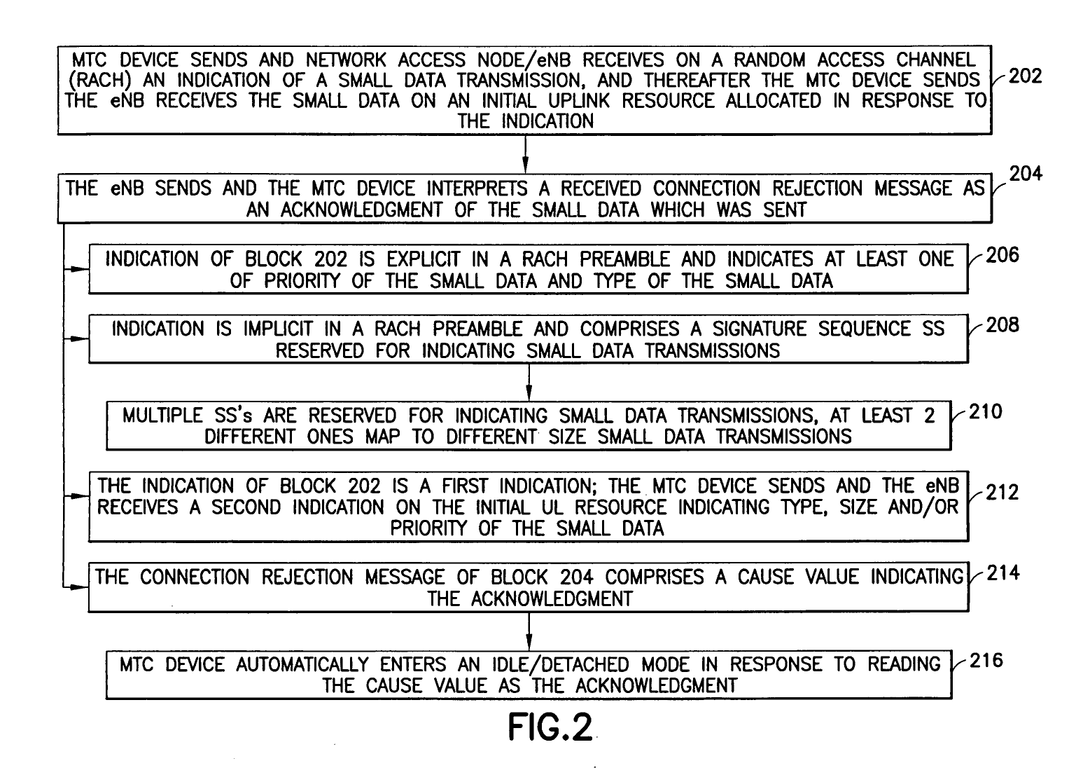

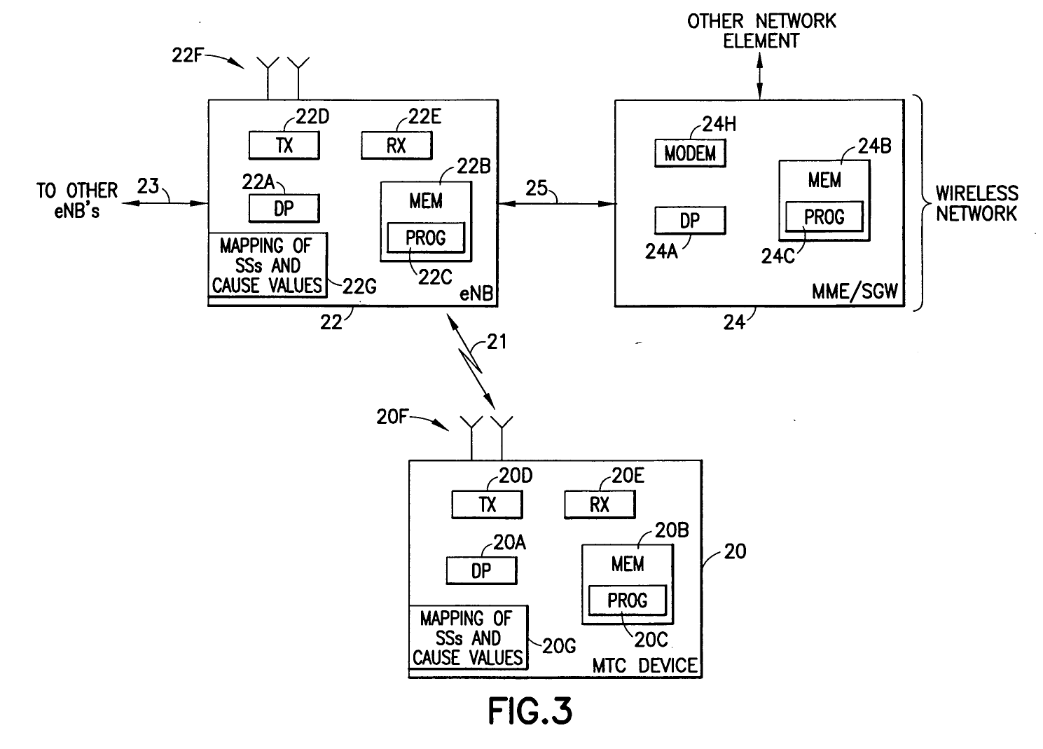

Now is described in more detail with reference to FIGS. 2 and 3 the exemplary embodiments of the invention which were summarized above. The signaling diagram at FIG. 1 utilizes ‘message 1’, ‘message 2’ etc. as is conventional for the RACH procedure in LTE so the distinctions of these teachings are more evident.

In RACH message 1 of FIG. 1, the UE or other MTC device 20 sends and the eNB 22 receives on the RACH an indication of a pending small data transmission, as detailed at block 202 of FIG. 2. By example the indication may be implicit as a specific RACH access preamble which is reserved for indicating the detached small data transmission as shown at block 208 of FIG. 2. The specific RACH access preamble (or the signature sequence in the preamble) may indicate the type and purpose of the small data transmission for MTC. If the data block size of the small data transmission is configurable, this size information could also be included in the RACH preamble access. For example, the eNB 22 may have stored in its local memory a mapping between the size and the RACH access preamble group. The MTC device 20 UE will also have this mapping stored in its own local memory so that when the MTC device 20 intends to send the offline data, the MTC device 20 will select the corresponding preamble/signature sequence as an implicit indication that there is a pending UL small data transmission and its size. This is noted at block 210 of FIG. 2. As noted above the indication of the pending small data transmission may alternatively be an explicit indication as shown at block 206 of FIG. 2.

In the conventional RACH procedure detailed at 3GPP TS 36.300 v8.9.0 (2009-06), the contention based random access procedure is used for initial access from RRC-idle state and for message 1 a random access preamble signature is randomly chosen by the UE, with the result that it is possible for more than one UE simultaneously to transmit the same signature, leading to a need for a subsequent contention resolution process.

In the RACH access response message 2 at FIG. 1, the eNB 22 allocates to the MTC device 20 an initial uplink resource allocation for small data transmission. The initial uplink resource allocation is scheduled according to the information provided in the RACH message 1. If the size of the small data amount is configurable, then the eNB 22 should be able to grant the resource allocation once according to the pre-configurations, types and priorities of the MTC device 20 as reported according to certain of the embodiments above for the indication which the MTC device 20 sends in message 1. Block 202 of FIG. 2 also reflects that the MTC device sends and the eNB receives the small data itself on an initial uplink resource allocated in response to the indication. In one embodiment this may be a UL-SCH. This initial uplink resource allocation is scheduled by the eNB 22 according to the information provided in the RACH message 1.

Block 212 of FIG. 2 states that there is a second indication (the first indication being the one noted at block 202) sent by the MTC device 20 and received by the eNB 22 with the small data which indicates at least one of type, size and priority of the small data. In this embodiment the initial UL resource that is allocated in response to the first indication (and on which the small data and the second indication are sent) may be a CCCH, rather than the above mentioned UL-SCH, and may include more detailed information about the priority/type/size of the small data if it was not in the first indication in the RACH preamble.

In the conventional RACH procedure of TS 36.300 referenced above, the random access response of message 2 is generated by the MAC layer in the eNB 22 and sent on the DL-SCH (specifically, the PDCCH). It is semi-synchronous with message 1, meaning it is sent within a flexible window of which the size is one or more TTIs. Also, there is no HARQ for message 2, it is addressed to the RA-RNTI used by the UE in message 1, and it conveys at least an identifier of the preamble used in message 1 as well as timing alignment information, an initial UL grant and an assignment of a temporary C-RNTI which may or may not be made permanent later upon contention resolution. Message 2 is conventionally intended for a variable number of UEs in one DL-SCH message, which is why it identifies both the preamble and the RA-RNTI. Some of all of these may be continued in certain embodiments of the modified RACH procedure shown at FIGS. 1 and 2.

In RACH message 3 shown at FIG. 1, the MTC device 20 sends the small data to the eNB according to the resource allocation in message 2. As above, in one embodiment this is an UL-SCH and in another embodiment specified at block 212 of FIG. 2 it is a CCCH.

In the conventional RACH procedure of TS 36.300 referenced above, the random access procedure scheduled transmission/message 3 is an UL-SCH which uses HARQ and the size of the transport blocks depends on the grant conveyed at message 2 (minimum 80 bits). For an initial access in the conventional RACH procedure message 3 would include the UE's RRC Connection Request generated by the UE's RRC layer and this request would also include a NAS identifier and would not utilize message segmentation.

Further at FIG. 1, the eNB 22 sends to the MTC device 20 at message 4 (contention resolution) a RRC Connection Reject message since the eNB 22 knows from the indication at message 1 that the purpose of the MTC device 20 engaging in this RACH procedure is only for sending its infrequent small data message. At block 204 of FIG. 2 the MTC device interprets this RRC connection reject message as an acknowledgement that the eNB 22 has properly received the small data sent in message 3. Block 214 of FIG. 2 gives a more detailed implementation in which there is a cause value which specifically indicates an acknowledgement of the offline small data transmission. By example both the eNB 22 and the MTC device 20 have stored in their local memories a mapping between that cause value and a meaning of acknowledging a small data transmission.

Finally, at block 216 of FIG. 2 the MTC device 20 automatically returns to the idle mode or detached mode without entering the connected mode in response to reading the cause value.

In conventional RACH procedures for LTE (e.g., section 6.26 of TS 36.300 referenced above), an eNB 22 will send a rejection of a RRC Connection and Channel request for potential overload issues caused by roaming UEs. Generally, the eNB does not wait for a NAS reply before resolving contention in conventional RACH procedures so message 4 is not synchronized with message 3 and there is no HARQ for message 4. Conventionally the message 4 is addressed to the temporary C-RNTI and sent on the PDCCH for initial access and after a radio link failure. Any HARQ feedback is transmitted only by the UE which detects its own UE identity, provided in message 3 and echoed in the Contention Resolution message 4. Additionally, there is no message segmentation for conventional initial access.

In general, the information transfer from the 3GPP network to the MTC server is in IP packets, and so the minimum size of the message is practically determined by the headers because the actual MTC control/measurement information can be only a few bits at minimum. Because the MTC device cannot wait for an acknowledgement packet of the TCP protocol, TCP/IP is not possible. Hence, non-acknowledged transmission is the only possibility for the MTC server, i.e., UDP/IP has to be used. The header size in IPv6 is 40 octets (without extension headers) and in UDP is 8 octets, yielding 48 octets plus at least 1 octet of data for a total of 49 octets. In addition, the core network protocol headers are needed, and also an authentication data field needs to be included in most cases.

Robust IP header compression (ROHC) between the MTC device 20 and the MTC server is not feasible in this situation. Any feedback would require multiple transactions and the compression contexts would be kept all the time active. Ordinary ROHC on the RAN level (in PDCP) also is not possible, because there is no bearer for the offline data transfer and maintaining the contexts in the network would be against the purpose of the offline mode. Thus the inventors consider that the message size sent according to these teachings is likely to be at minimum in order of 60 to 70 octets, assuming the actual MTC user data/information is less than a few octets. For RACH message 3, the size of the transport blocks depends on the UL grant conveyed in message 2 as noted above, and is at least 80 bits. Therefore there are no obstacles concerning the transmission size of RACH message 3 as adapted for offline small data transmission according to these teachings.

FIG. 2 detailed above is a logic flow diagram illustrating exemplary but non-limiting embodiments of the invention from the perspective of the MTC device 10 and of the eNB 22, and may represent method steps, actions taken by an MTC device or eNB in response to stored software arranged according to these embodiments, or the actual MTC device/eNB themselves configured according to these teachings.

The blocks of FIG. 2 and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

One technical effect and advantage of these exemplary embodiments is that for the infrequent small data transmissions, there is no need to frequently run detach and attach procedures. Consequently, implementation of these teachings will save in radio resources because the signaling overhead is low relative to the volume/size of the offline MTC device small data which is transmitted by the MTC device 20. Additionally, the exemplary procedures detailed above are fully backward compatible with current LTE specifications except that some minor signaling overhead and the pre-configuration is required to be updated to legacy devices (e.g., firmware updates appear quite viable).

Reference is now made to FIG. 3 for illustrating a simplified block diagram of various electronic devices and apparatus that are suitable for use in practicing the exemplary embodiments of this invention. In FIG. 3 a wireless network is adapted for communication over a wireless link 21 with an apparatus, such as a mobile terminal/UE or other such MTC device 20, via a network access node, such as a base or relay station or more specifically an eNB 22. The network may include a network control element MME/SGW 24, which provides connectivity with further networks (e.g., a publicly switched telephone network PSTN and/or a data communications network/Internet) as well as other network elements such as the MTC server noted above. The MTC device 20 may be any host device of a MTC-specific SIM card, or an ordinary SIM card, or a device without any SIM card.

The MTC device 20 includes processing means such as at least one data processor (DP) 20A, storing means such as at least one computer-readable memory (MEM) 20B storing at least one computer program (PROG) 20C executable by the MTC device 20 which cause the device 20 to perform actions as detailed above, communicating means such as a transmitter TX 20D and a receiver RX 20E for bidirectional wireless communications with the eNB 22 via one or more antennas 20F. Also stored in the MEM 20B at reference number 20G is the algorithm and possibly lookup tables which the MTC device 20 utilizes to map the reserved signature sequences (SSs at FIG. 3) to the small data transmission purpose (and possibly small data size) and also to map the cause value(s) to mean acknowledgments of small data transmissions. The SIM card is not specifically shown but if present for implementing these teachings in a MTC device 20 includes a processor and a memory storing the mapping algorithm and/or lookup tables 20G.

The eNB 22 also includes processing means such as at least one data processor (DP) 22A, storing means such as at least one computer-readable memory (MEM) 22B storing at least one computer program (PROG) 22C executable by the eNB 22 which cause the device 22 to perform actions as detailed above, and communicating means such as a transmitter TX 22D and a receiver RX 22E for bidirectional wireless communications with the UE 20 via one or more antennas 22F. There is a data and/or control path 25 coupling the eNB 22 with the MME/SGW 24, and another data and/or control path 23 coupling the eNB 22 to other eNB's/access nodes. The eNB 22 stores also the algorithm or lookup tables for doing its own mapping 22G similar to that noted above for the MTC device 20.

Similarly, the MME/SGW 24 includes processing means such as at least one data processor (DP) 24A, storing means such as at least one computer-readable memory (MEM) 24B storing at least one computer program (PROG) 24C of executable instructions, and communicating means such as a modem 24H for bidirectional wireless communications with the eNB 22 via the data/control path 25. While not particularly illustrated for the UE 20 or eNB 22, those devices are also assumed to include as part of their wireless communicating means a modem which may be inbuilt on an RF front end chip within those devices 20, 22 and which also carries the TX 20D/22D and the RX 20E/22E. Such a modem implementing embodiments of these teachings may have its own memory for storing the above-detailed reserved signature sequences and cause values and how they are mapped.

At least one of the PROGs 20C in the MTC device 20 is assumed to include a set of program instructions that, when executed by the associated DP 20A, enable the device to operate in accordance with the exemplary embodiments of this invention, as detailed above. The eNB 22 and MME/SGW 24 may also have software to implement certain aspects of these teachings for signaling and mapping values as detailed above. In these regards the exemplary embodiments of this invention may be implemented at least in part by computer software stored on the MEM 20B, 22B which is executable by the DP 20A of the MTC device 20 and/or by the DP 22A of the eNB 22, or by hardware, or by a combination of tangibly stored software and hardware (and tangibly stored firmware). Electronic devices implementing these aspects of the invention need not be the entire MTC device 20 or eNB 22, but exemplary embodiments may be implemented by one or more components of same such as the above described tangibly stored software, hardware, firmware and DP, an application specific integrated circuit ASIC or a system on a chip SOC such as a MTC-specific SIM card.

In general, the various embodiments of the MTC device 20 can include, but are not limited to personal portable digital devices having wireless communication capabilities, including but not limited to cellular telephones, navigation devices, laptop/palmtop/tablet computers, digital cameras, music devices, and Internet appliances.

Various embodiments of the computer readable MEMs 20B and 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A and 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the E-UTRAN/LTE system, it should be appreciated that the exemplary embodiments of this invention are not limited for use with only this one particular type of wireless communication system, and that they may be used to advantage in other wireless communication systems such as for example UTRAN, GERAN and GSM and others which may utilize a RACH procedure by which detached UEs can become attached to the network.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least:
send on a random access channel an indication of a small data transmission, and thereafter send the small data on an initial uplink resource allocated in response to the indication; and
interpret a received connection rejection message as an acknowledgement of the small data which was sent.

2. The apparatus according to claim 1, in which the indication is explicit in a preamble sent on the random access channel and indicates at least one of priority, type and size of the small data.

3. The apparatus according to claim 1, in which the indication is implicit in a preamble sent on the random access channel and comprises a signature sequence reserved for indicating small data transmissions.

4. The apparatus according to claim 3, in which the signature sequence is selected from a group of at least two signature sequences reserved for indicating small data transmissions, and each of the at least two signature sequences map to a different size small data transmission.

5. The apparatus according to claim 1, in which said indication is a first indication;
and the at least one memory with the computer program is configured with the at least one processor to cause the host device further to send with the small data a second indication which indicates at least one of type, size and priority of the small data.

6. The apparatus according to claim 5, in which the initial uplink resource on which the small data is sent comprises a common control channel.

7. The apparatus according to claim 1, in which the connection rejection message comprises a cause value indicating the acknowledgement.

8. The apparatus according to claim 7, in which the apparatus comprises one of a modem and a subscriber identity module disposed in a host device;
and the at least one memory with the computer program is configured with the at least one processor to cause the host device further to enter an idle or a detached mode automatically in response to reading the cause value as the acknowledgement.

9. A method, comprising:
sending on a random access channel an indication of a small data transmission, and thereafter sending the small data on an initial uplink resource allocated in response to the indication; and
interpreting a received connection rejection message as an acknowledgement of the small data which was sent.

10. The method according to claim 9, in which the indication is explicit in a preamble sent on the random access channel and indicates at least one of priority, type and size of the small data.

11. The method according to claim 9, in which the indication is implicit in a preamble sent on the random access channel and comprises a signature sequence reserved for indicating small data transmissions.

12. The method according to claim 11, in which the signature sequence is selected from a group of at least two signature sequences reserved for indicating small data transmissions, and each of the at least two signature sequences map to a different size small data transmission.

13. The method according to claim 9, in which said indication is a first indication; the method further comprising:
sending with the small data a second indication which indicates at least one of type, size and priority of the small data.

14. The method according to claim 13, in which the initial uplink resource on which the small data is sent comprises a common control channel.

15. The method according to claim 9, in which the connection rejection message comprises a cause value indicating the acknowledgement.

16. The method according to claim 15, in which the method is executed by a host device having at least one of a modem and a subscriber identity module disposed therein; the method further comprising:
the host device entering an idle or a detached mode automatically in response to reading the cause value as the acknowledgement.

17. A computer readable memory storing a set of instructions, which, when executed by an apparatus, causes the apparatus to:
send on a random access channel an indication of a small data transmission, and thereafter send the small data on an initial uplink resource allocated in response to the indication; and
interpret a received connection rejection message as an acknowledgement of the small data which was sent.

18. The computer readable memory according to claim 17, in which the indication is explicit in a preamble sent on the random access channel and indicates at least one of priority, type and size of the small data.

19. The computer readable memory according to claim 17, in which the indication is implicit in a preamble sent on the random access channel and comprises a signature sequence reserved for indicating small data transmissions.

20. The computer readable memory according to claim 17, in which the connection rejection message comprises a cause value indicating the acknowledgement.

21.-40. (canceled)
